(19) United States
(12) Patent Application Publication
(10) Pub. No.: US 2012/0115059 A1
(43) Pub. Date: May 10, 2012

(54) ELECTRICITY OUTPUT MANAGING SYSTEM FOR A FUEL CELL STACK

(75) Inventors: CHI-YUAN LEE, TAIPEI (TW); FANG-BOR WENG, TAOYUAN (TW); AY SU, TAOYUAN COUNTY (TW); SHIH-HUNG CHAN, TAOYUAN COUNTY (TW); GUO-BIN JUNG, TAOYUAN COUNTY (TW); MING-SHAO TANG, HSINGCHU COUNTY (TW); CHI-PING CHANG, TAICHUNG COUNTY (TW); TIEN-FU YANG, TAOYUAN CITY (TW)

(73) Assignee: YUAN ZE UNIVERSITY, TAOYUAN COUNTY (TW)

(21) Appl. No.: 12/939,466

(22) Filed: Nov. 4, 2010

(51) Int. Cl. H01M 8/04

(52) U.S. Cl. 429/442

(57) ABSTRACT

An electricity output managing system for a fuel cell stack is disclosed. It includes a fuel cell stack, many power switches, an electricity adjusting module, multiple thermal sensors, and a controller. This electricity adjusting module is provided to combine the electricity outputs from these power switches into a single final output. The thermal sensors can detect the inner temperature values of the fuel cell units. The controller can receive the inner temperature values via these thermal sensors and calculate an average of all the inner temperature values which is a floating one. When one of the inner temperature values falls outside a normal range or one of the inner temperature value's variation rates exceeding a preset reference value, the controller turns off the power switch of the corresponding fuel cell unit and sends out a warning signal. So, it can effectuate the fuel cell management by monitoring the inner temperatures of these fuel cell units. The managing system is judged by its floating average temperature. In addition, it can detect any abnormal fuel cell unit inside a fuel cell stack.

### BACKGROUND OF THE INVENTION

1. Field of the Invention

The present invention relates to electricity output managing system for a fuel cell stack. In which, it can effectuate the fuel cell management by monitoring the inner temperatures of these fuel cell units. The managing system is judged by its floating average temperature. In addition, it can detect any abnormal fuel cell unit inside a fuel cell stack.

2. Description of the Prior Art

Fuel cell technology has become increasingly sophisticated in recent years. A traditional fuel cell stack 200 (as shown in FIG. 6) usually is constituted by dozens or hundreds fuel cell units 20 stacked together. Each fuel cell 20 include a membrane electrode assembly (briefly referred as MEA) 201, an anode layer 202, a cathode layer 203, and a pair of bipolar plates 204. Of course, the adjacent bipolar plates 204 of neighboring fuel cell units 20 can be combined as one integral plate (or sharing one plate). Besides, the integral plate (also labeled as 204) has both sides. Each side has one or more flow channels.

However, the traditional fuel cell stack still has the following disadvantages and problems.

[1] A general battery management's focus is only on its voltage or current output. Temperature variation is one of the important factors to determine whether this fuel cell stack is normal or not. Before the fuel cell stack is break down, its voltage or current output might be kept within a preset range, but its internal temperature will increase obviously. If each fuel cell unit is treated as a battery, a general battery management only monitors its voltage or current output. Once the voltage or current increases above a preset level, a warning signal is generated and a necessary action (such as turned off) might be taken. Therefore, the traditional method is not based on its internal temperature variation. Therefore, it is hard to detect its internal temperature variation when it is breaking down.

[2] The temperature control of a fuel cell stack is based on a fixed value rather than a floating value. Assuming some thermal sensors are embedded inside a fuel cell stack, it is possible to detect the inner temperature. It usually contains one or more fixed values such as a fixed upper limit or a fixed lower limit (for example, 55° C. and 45° C.). However, the chemical reaction inside the fuel cell is very complicated. It might be influenced by many factors, such as the supplying volume of the reacting gases changes, the temperature of the entering gas becomes higher or lower, the inner water is jammed in the channel, and so on. Therefore, when the operating condition changes, the fixed value has to be reset or changed again. Thus, it is really troublesome.

[3] It is hard to know one of the fuel cell units in the entire fuel cell stack breaks down or not. When one of dozens or hundreds fuel cell units is out of order, the inner temperature of that one becomes unstable. If such unstable temperature fluctuation is within a fixed range, it still is considered normal. Under this condition, the abnormal condition cannot be detected and known.

### SUMMARY OF THE INVENTION

The object of the present invention relates to an electricity output managing system for a fuel cell stack. In which, it can effectuate the fuel cell management by monitoring the inner temperatures of these fuel cell units. The managing system is judged by its floating average temperature. In addition, it can detect any abnormal fuel cell units inside a fuel cell stack. Hence, it can solve the traditional device's problems as follows. A general battery management's focus is only on its voltage or current output. The temperature control of a fuel cell stack is based on a fixed value rather than a floating value. Plus, it is hard to know one of the fuel cell units in the entire fuel cell stack breaks down or not.

In order to solve the above mentioned problems, a technical solution is provided. An electricity output managing system for a fuel cell stack comprising:

a fuel cell stack having a plurality of fuel cell units stacked together, a first gas inlet, a first gas outlet, a second gas inlet, and a second gas outlet;

a plurality of power switches connecting to the fuel cell units respectively so as to control electricity outputs of the fuel cell units;

an electricity adjusting module for combining a plurality electricity outputs from the power switches into a single final output which has a higher voltage;

a plurality of thermal sensors disposed inside the fuel cell units respectively so as to detect the inner temperature values of the fuel cell units;

a controller receiving the inner temperature values via the thermal sensors and calculating an average of all the inner temperature values, the average being defined as a floating average temperature, a normal range being defined between the floating average temperature adding a predetermined percentage and the floating average temperature deducting the predetermined percentage, the predetermined percentage being defined between 3% and 30%;

wherein when one of the inner temperature values falls outside the normal range, the controller turns off the power switch of the corresponding fuel cell unit and sends out a first warning signal; and

when one of the inner temperature value's variation rates exceeding a predetermined reference value, the controller turns off the power switch of the corresponding fuel cell unit and sends out a second warning signal; the inner temperature value's variation rate being defined as a derivative of the inner temperature with respect to time.

### BRIEF DESCRIPTION OF THE DRAWINGS

FIG. 1 is an exploded view of the present invention.

FIG. 2 shows the structure of the present invention.

FIG. 3 is a perspective view of the present invention.

FIG. 4 illustrates the curves of the temperature variations in the fuel cell stack.

FIG. 5 illustrates a curve of the average of the inner temperatures of these fuel cell units.

FIG. 6 is a view showing the traditional fuel cell stack.

### DETAILED DESCRIPTION OF THE PREFERRED EMBODIMENT

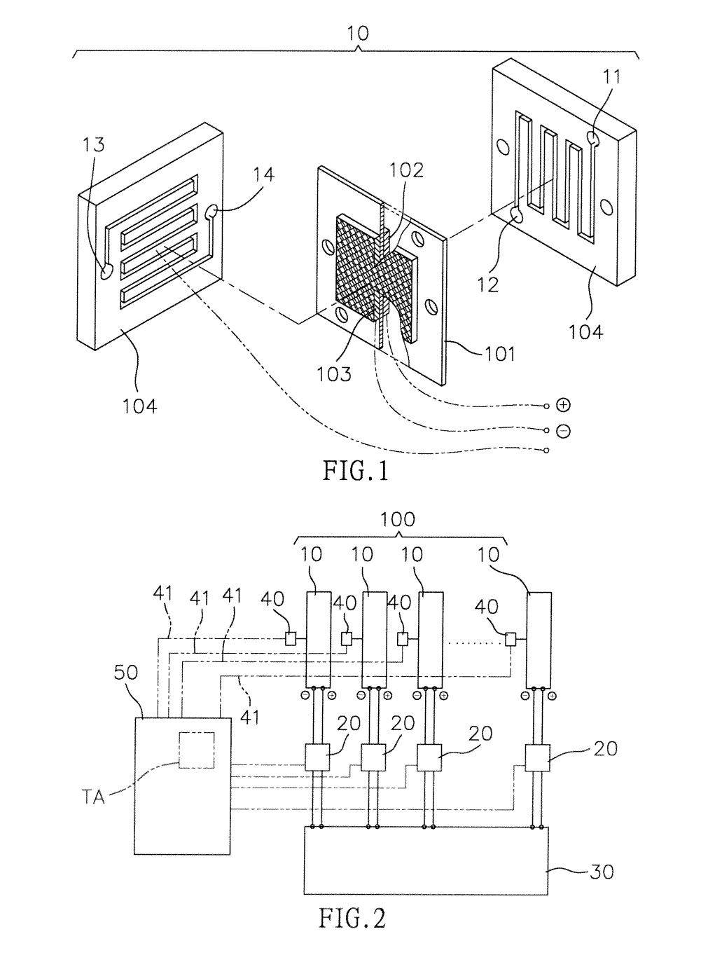

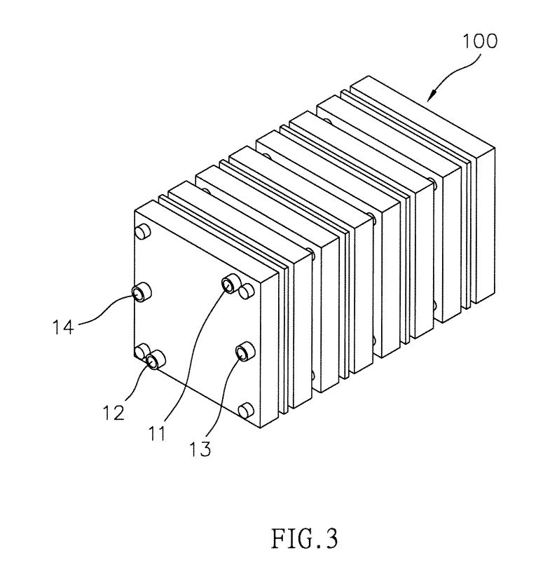

Referring to FIGS. 1 and 2, this invention is an electricity output managing system for a fuel cell stack. It mainly comprises a fuel cell stack 100, many power switches 20, an electricity adjusting module 30, a plurality of thermal sensors 40, and a controller 50.

About this fuel cell stack 100, it includes a plurality of stacked fuel cell units 10 (can be seen in FIGS. 2 and 3), a first gas inlet 11, a first gas outlet 12, a second gas inlet 13, and a second gas outlet 14.

With regard to these power switches 20, they connect to the fuel cell units 10 respectively so as to control electricity outputs of the fuel cell units 10.

The electricity adjusting module 30 is provided for combining a plurality electricity outputs from these power switches 20 into a single final output which has a higher voltage (higher than each electricity output from one fuel cell 10).

Concerning these thermal sensors 40, they are disposed inside the fuel cell units 10 respectively so as to detect the inner temperature values 41 of the fuel cell units 10.

About this controller 50, it can receive the inner temperature values 41 via these thermal sensors 40 and calculate an average of all the inner temperature values 41. The average is defined as a floating average temperature TA (as shown in Table 1). A normal range is defined between the floating average temperature TA adding a predetermined percentage and the floating average temperature TA deducting the afore-mentioned predetermined percentage. The predetermined percentage can be defined between 3% and 30%.

In addition, when one of the inner temperature values 41 (of a fuel cell 10) falls outside the normal range (that means an abnormal state), this controller 50 turns off the power switch 20 of the corresponding fuel cell unit 10 and sends out a first warning signal.

Also, when one of the inner temperature values' variation rates exceeds a predetermined reference value or range (that also mean an abnormal state), the controller 50 turns off the power switch 20 of the corresponding fuel cell unit 10 and sends out a second warning signal. Meanwhile, the inner temperature value's variation rate is defined as a derivative of the inner temperature with respect to time.

Practically, the predetermined reference value is set as a variation of the inner temperature value 41 exceeding ±5° C. per minute (or other vale).

More specifically, each fuel cell unit 10 includes a membrane electrode assembly 101, an anode layer 102, a cathode layer 103, and a pair of bipolar plates 104. Of course, the adjacent bipolar plates 104 of neighboring fuel cell units 10 can be combined as one integral plate (or sharing one plate). Besides, the integral plate (also labeled as 104) has both sides. Each side has one or more flow channels.

A fuel cell stack 100 having three fuel cell units 10 is used as a simplified example for explaining the operation of this invention. Actually, it can apply to other condition which is more than three or less than three.

The thermal sensors 40 of these three fuel cell units 10 (called unit No 1, No. 2 and No. 3) detect the inner temperature values 41 (unit: ° C.) at different times as listed in the Table 1.

TABLE 1

| Item | 30th min. | 50th min. | 60the min. | 92nd min. | 93rd min. |
|---|---|---|---|---|---|
| Unit No. 1 | T11 = 52.1 | T21 = 56.6 | T31 = 56.5 | T41 = 56.4 | T51 = 56.4 |
| Unit No. 2 | T12 = 52.3 | T22 = 56.4 | T32 = 56.4 | T42 = 56.5 | T52 = 51.0 |
| Unit No. 3 | T13 = 52.2 | T23 = 56.5 | T33 = 73.7 | T43 = 56.3 | T53 = 56.7 |
| Average | TA1 = 52.2 | TA2 = 56.5 | TA3 = 62.2 | TA4 = 56.4 | TA5 = 54.7 |

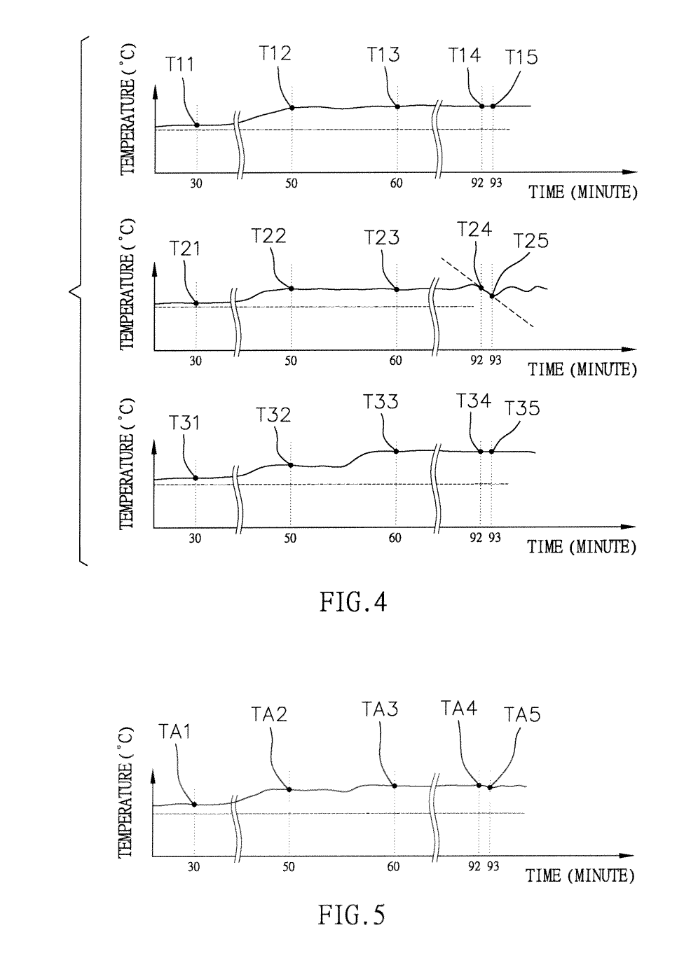

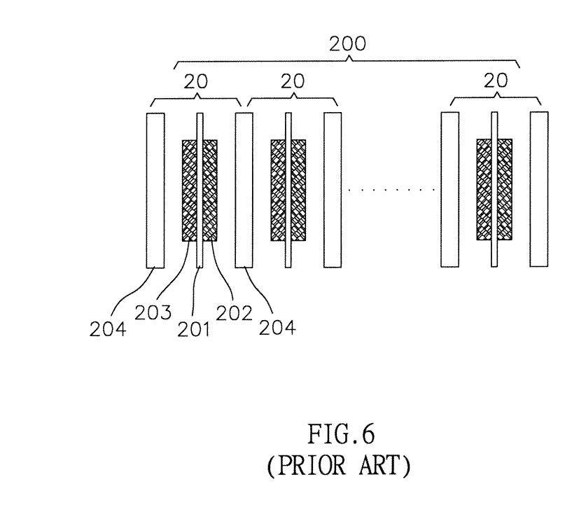

As shown in FIG. 4, when it is at the 30th minute (briefly referred as min.), because the inner temperature values (T11=52.1° C., T12=52.3° C., T13=52.2° C. respectively) are all falling within the average (TA1, as shown in FIG. 5) 52.2° C.±5% (that means 49.59° C.˜54.81° C.), it is considered as a normal state.

While it is at the 50th minute, all these inner temperature values are still falling within the average (TA2) 56.5° C.±5%. Although all these inner temperature values increase, it is considered as a normal state. It might be caused by load increasing when supplying gases increasing accordingly, or caused by supplying different gas changes so that its reaction temperature differs.

Furthermore, while it is at the 60^{th} minute, the unit no. 3 (the third fuel cell 10) suddenly soars to 73.7° C. Under this condition, it exceeds the average 62.2° C. (TA3) ±5% (that means 59.09° C.˜65.31° C.) at that time. It will be considered as an abnormal state by the controller 50. Hence, this controller 50 turns off the power switch 20 of the corresponding fuel cell unit 10 and sends out a first warning signal.

While it is at the 92nd minute and the 93rd minute, the unit no. 2 (as shown in the T24˜T25 in FIG. 4 of the second fuel cell 10) has a larger temperature fluctuation. The temperature value's variation rate is calculated as follows.

$$\frac{d T}{d t} = \frac{Δ T}{Δ t} = \frac{T 25 - T 24}{93 - 92} = \frac{51.0 - 56.5}{1} = - {5.5}^{°} \text{C./} min$$

Because it exceeds the ±5° C. per minute, it is considered such instantaneous variation is too large. Hence, the controller 50 turns off the power switch 20 of the corresponding fuel cell unit 10 (in this case, the unit no. 2) and sends out a second warning signal.

No matter how many fuel cell units 10, the controller 50 will operate based on the same principle as described previously.

Therefore, the advantages and functions of the present invention can be summarized as follows.

[1] It can effectuate the fuel cell management by monitoring the inner temperatures of these fuel cell units. Most fuel cell management method is based on the stability of the voltage or current output. However, when the fuel cell becomes abnormal (its temperature will vary), the voltage or current output might not fluctuate too much within a short time. Under this condition, it is hard to detect the abnormal condition. But, this invention, every fuel cell unit contains a thermal sensor and a power switch. If any fuel cell unit becomes abnormal, the power switch will be turned off and the controller will send out a warning signal. Thus, it is helpful for maintenance or repairing.

[2] The managing system is judged by its floating average temperature. The inner temperature of the fuel cell stack in this invention is judged by its floating average temperature. For example, assuming this fuel cell stack is constituted by three fuel cell units, the inner temperatures of these three fuel cell units are measured as 52.1° C., 52.3° C., and 52.2° C. at the 30^{th} minute respectively. Because they are within the range of 52.2° C.±5% (that is between the range of 49.59° C. to 54.81° C.), it is considered normal. Based on such design, this invention is possible to be used by supplying different reaction gases (different reaction might cause different heat generating). It can reduce the misjudging rate. Therefore, this kind of floating average temperature judging method is quite novel.

[3] It can detect any abnormal fuel cell unit inside a fuel cell stack. If the detected temperature of one fuel cell unit in the fuel cell stack is 53.8° C. at the 32^{nd} minute, the afore-mentioned temperature becomes 60.3° C. at the 33^{rd} minute. The temperature variation rate is calculated as listed below.

$$\frac{d T}{d t} = \frac{Δ T}{Δ t} = \frac{T 33 - T 32}{33 - 32} = \frac{60.3 - 53.8}{1} = {6.5}^{°} \text{C./} min$$

Because this variation rate exceeds ±5° C. per minute (this preset value can be altered depending upon the user), it is considered as an abnormal state. Accordingly, the power switch of this abnormal fuel cell will be turned off. Thus, it can quickly detect any abnormal fuel cell in this fuel cell stack.

While this invention has been particularly shown and described with references to the preferred embodiments thereof, it will be understood by those skilled in the art that various changes or modifications can be made therein without departing from the scope of the invention by the appended claims.

What is claimed is:

1. An electricity output managing system for a fuel cell stack comprising:
a fuel cell stack having a plurality of fuel cell units stacked together, a first gas inlet, a first gas outlet, a second gas inlet, and a second gas outlet;
a plurality of power switches connecting to said fuel cell units respectively so as to control electricity outputs of said fuel cell units;
an electricity adjusting module for combining a plurality electricity outputs from said power switches into a single final output which has a higher voltage;
a plurality of thermal sensors disposed inside said fuel cell units respectively so as to detect said inner temperature values of said fuel cell units;
a controller receiving said inner temperature values via said thermal sensors and calculating an average of all said inner temperature values, said average being defined as a floating average temperature, a normal range being defined between said floating average temperature adding a predetermined percentage and said floating average temperature deducting said predetermined percentage, said predetermined percentage being defined between 3% and 30%;
wherein when one of said inner temperature values falls outside said normal range, said controller turns off said power switch of said corresponding fuel cell unit and sends out a first warning signal; and
when one of said inner temperature value's variation rates exceeding a predetermined reference value, said controller turns off said power switch of said corresponding fuel cell unit and sends out a second warning signal; said inner temperature value's variation rate being defined as a derivative of said inner temperature with respect to time.

2. The electricity output managing system for a fuel cell stack as claimed in claim 1, wherein said predetermined reference value be set as a variation of said inner temperature value exceeding ±5° C. per minute.

3. The electricity output managing system for a fuel cell stack as claimed in claim 1, wherein each fuel cell unit includes a membrane electrode assembly, an anode layer, a cathode layer, and a pair of bipolar plates.

4. The electricity output managing system for a fuel cell stack as claimed in claim 3, wherein
said adjacent bipolar plates of neighboring fuel cell units being combined as an integral plate; and
said integral plate having both sides, each side having one or more flow channels.
